(19) United States
(12) Patent Application Publication
(10) Pub. No.: US 2022/0243057 A1
(43) Pub. Date: Aug. 4, 2022

(54) POLYOL ESTER-BASED FOAM ADDITIVES FOR POLYURETHANE DISPERSIONS HAVING HIGH FILLER CONTENTS

(71) Applicant: Evonik Operations GmbH, Essen (DE)

(72) Inventors: Michael Klostermann, Essen (DE); Kai-Oliver Feldmann, Essen (DE); Jan Marian von Hof, Bochum (DE); Verena Dahl, Bergisch Gladbach (DE); Marvin Jansen, Essen (DE); Sina Arnold, Bottrop (DE); YeChen Le, Shanghai (CN)

(73) Assignee: Evonik Operations GmbH, Essen (DE)

(21) Appl. No.: 17/612,690

(22) PCT Filed: Jul. 9, 2019
(86) PCT No.: PCT/CN2019/095209

§ 371 Date: Nov. 19, 2021

(51) Int. Cl. C08L 71/02; C09D 175/08; D06N 3/00; D06N 3/14

(52) U.S. Cl. CPC C08L 71/02; C09D 175/08; D06N 3/14; D06N 3/0061; D06N 3/0063; D06N 3/0047

(57) ABSTRACT

The joint use of polyol esters and ethylene oxide-rich alkyl alkoxylates as additives in filler-containing aqueous polymer dispersions for production of porous polymer coatings, preferably for production of porous polyurethane coatings, is described.

### CROSS REFERENCE TO RELATED APPLICATIONS

This application is a 35 U.S.C. § 371 U.S. national phase entry of International Application No. PCT/CN2019/095209 having an international filing date of Jul. 9, 2019, incorporated herein by reference in its entirety.

### FIELD

The present invention is in the field of plastics coatings and synthetic leathers.

It relates more particularly to the production of porous polymer coatings, preferably porous polyurethane coatings, comprising fillers, using polyol ester-based foam additives.

### BACKGROUND

Textiles coated with plastics, for example synthetic leathers, generally consist of a textile carrier onto which is laminated a porous polymer layer which has in turn been coated with a top layer or a topcoat.

The porous polymer layer in this context preferably has pores in the micrometre range and is air-permeable and hence breathable, i.e. permeable to water vapor, but water-resistant. The porous polymer layer often comprises porous polyurethane. At present, porous polyurethane layers are usually produced by a coagulation method in which DMF is used as solvent. Owing to environmental concerns, however, this production method is being increasingly criticized, and so it is to be succeeded gradually by other, more environmentally friendly technologies. One of these technologies is based on aqueous polyurethane dispersions, called PUDs. These generally consist of polyurethane microparticles dispersed in water; the solids content is usually in the range of 30-60% by weight. For production of a porous polyurethane layer, these PUDs are mechanically foamed, coated onto a carrier (layer thicknesses typically between 300-2000 μm) and then dried at elevated temperature. During this drying step, the water present in the PUD system evaporates, which results in formation of a film of the polyurethane particles. In order to further increase the mechanical strength of the film, it is additionally possible to add hydrophilic (poly)isocyanates to the PUD system during the production process, and these can react with free OH radicals present on the surface of the polyurethane particles during the drying step, thus leading to additional crosslinking of the polyurethane film.

Both the mechanical and the tactile properties of PUD coatings thus produced are determined to a crucial degree by the cell structure of the porous polyurethane film. In addition, the cell structure of the porous polyurethane film affects the air permeability and breathability of the material. Particularly good properties can be achieved here with very fine, homogeneously distributed cells. A customary way of influencing the cell structure during the above-described production process is to add surfactants to the PUD system before or during the mechanical foaming. A first effect of appropriate surfactants is that sufficient amounts of air can be beaten into the PUD system during the foaming operation. Secondly, the surfactants have a direct effect on the morphology of the air bubbles produced. The stability of the air bubbles is also influenced to a crucial degree by the type of surfactant. This is important especially during the drying of foamed PUD coatings, since it is possible in this way to prevent drying defects such as cell coarsening or drying cracks.

It is frequently the case that fillers are additionally added to the PUD system before or during the mechanical foaming, often in quite high concentrations. These may be, for example, inorganic fillers such as kaolin, calcium carbonate or ammonium polyphosphate, and organic fillers, for example lignin or celluloses. Fillers may be used, for example, to improve the mechanical and tactile properties of the foam coatings produced, but also serve to improve flame retardancy or thermal conductivity. However, the use of such fillers, especially in high concentrations, can be associated with a number of disadvantages. For instance, it is possible that, in the case of high filler concentrations, the viscosity of the PUD system rises to such an extent that it becomes virtually unmanageable. High viscosities here prevent sensible foaming of the PUD system. In other words, only little air, if any, can be beaten in; the resultant foam structure is often coarse and irregular. Moreover, high viscosities prevent sensible application of the foamed PUD to a carrier, which results in faults and defects in the foam coating. Furthermore, fillers, especially at high concentrations, can have an adverse effect on the stability of the foams produced, which can result in foam ageing during the processing of the foamed PUD system, which in turn leads to faults and defects in the foam coatings produced.

### SUMMARY

The problem addressed by the present invention was therefore that of providing additives for production of foam systems and foam coatings from aqueous polymer dispersions, especially for production of PUD-based foam systems and foam coatings, which, even in systems having high filler contents of 5-70% by weight, preferably of 10-50% by weight, even more preferably of 15-45% by weight and most preferably of 20-40% by weight, based on the total weight of the aqueous polymer dispersion, enable efficient foaming and efficient processing.

It has been found that, surprisingly, the use of polyol esters in combination with ethylene oxide-rich alkyl alkoxylates enables the solution of the stated problem. Ethylene oxide-rich alkyl alkoxylates in the context of this invention have at least 5, preferably at least 10, even more preferably at least 15 and most preferably at least 20 ethylene oxide units. Ethylene oxide-rich alkyl alkoxylates usable with preference are described more specifically hereinafter.

### DETAILED DESCRIPTION

The present invention therefore provides for the joint use of polyol esters and ethylene oxide-rich alkyl alkoxylates as additives, preferably as foam additives in aqueous polymer dispersions, preferably in aqueous polyurethane dispersions, particular preference being given to filler-containing aqueous polyurethane dispersions.

The joint use according to the invention of polyol esters and ethylene oxide-rich alkyl alkoxylates as foam additives surprisingly has a multitude of advantages here, especially in filler-containing aqueous polyurethane dispersions, also referred to in simplified form hereinafter as filler-containing PUD systems.

One advantage here is that the joint use according to the invention of polyol esters and ethylene oxide-rich alkyl alkoxylates as foam additives in filler-containing PUD systems even at high filler contents of 5-70% by weight, preferably of 10-50% by weight, even more preferably of 15-45% by weight and most preferably of 20-40% by weight, based on the total weight of the aqueous polymer dispersion, affords sufficiently low viscosities and hence good processibility of the system is still possible.

A further advantage is that the joint use according to the invention of polyol esters and ethylene oxide-rich alkyl alkoxylates enables efficient foaming especially of filled PUD systems, even in the case of high filler contents. In this way, it is firstly possible to beat sufficient amounts of air into the system. The foams thus produced are additionally notable for an exceptionally fine pore structure with particularly homogeneous cell distribution, which in turn has a very advantageous effect on the mechanical and tactile properties of the porous polymer coatings which are produced on the basis of these foams. In addition, it is possible in this way to improve the air permeability or breathability of the coating.

A further advantage is that the joint use according to the invention of polyol esters and ethylene oxide-rich alkyl ethoxylates enables the production of particularly stable foams, especially based on filled PUD systems, even in the case of high filler contents. This firstly has an advantageous effect on the processibility of the foams thus produced. Secondly, the elevated foam stability has the advantage that, during the drying of corresponding foams, drying defects such as cell coarsening or drying cracks can be avoided. Furthermore, the improved foam stability enables quicker drying of the foams, which offers processing advantages, both from an environmental and from an economic point of view.

The use of polyol esters as foam additives in aqueous polymer dispersions has already been described in detail in document WO2018/015260A1. For the further description of the polyol esters in the context of the present invention, this document is referred to in full.

The term “polyol esters” in the context of the entire present invention also includes the alkoxylated adducts thereof that can be obtained by reaction of a polyol ester with alkylene oxides, for example ethylene oxides, propylene oxide and/or butylene oxide.

The term “polyol esters” in the context of the entire present invention also includes the ionic derivatives thereof, preferably phosphorylated and sulfated derivatives, especially phosphorylated polyol esters. These derivatives of the polyol esters, especially phosphorylated polyol esters, are polyol esters usable with preference in accordance with the invention. These and other derivatives of the polyol esters are described in detail further down, and are usable with preference in the context of the invention.

The term “filler” in the context of the present invention describes additives that are insoluble or only sparingly soluble and are added to the aqueous polymer dispersion. “Sparingly soluble” in this context means that, at 25° C., less than 0.5% by weight, preferably less than 0.25% by weight and even more preferably less than 0.1% by weight of the filler dissolves in water. Fillers usable with preference are described more specifically further down.

The invention is described further and by way of example hereinafter, without any intention that the invention be restricted to these illustrative embodiments. Where ranges, general formulae or classes of compounds are specified hereinbelow, these are intended to encompass not only the corresponding ranges or groups of compounds which are explicitly mentioned but also all subranges and subgroups of compounds which can be obtained by removing individual values (ranges) or compounds. When documents are cited in the context of the present description, the contents thereof, particularly with regard to the subject matter that forms the context in which the document has been cited, are considered in their entirety to form part of the disclosure content of the present invention. Unless stated otherwise, percentages are figures in per cent by weight. When parameters which have been determined by measurement are reported below, the measurements have been carried out at a temperature of 25° C. and a pressure of 101 325 Pa, unless stated otherwise. Where chemical (empirical) formulae are used in the present invention, the specified indices may be not only absolute numbers but also average values. The indices relating to polymeric compounds are preferably average values. The structure and empirical formulae presented in the present invention are representative of all isomers feasible by differing arrangement of the repeating units.

In the context of the present invention, preferred polyol esters are especially those that are obtainable by the esterification of a polyol with at least one carboxylic acid. This corresponds to a preferred embodiment of the invention.

Preferred polyols used for preparation of the polyol esters according to the invention are selected from the group of the C₃-C₈ polyols and the oligomers and/or co-oligomers thereof. Co-oligomers result from reaction of different polyols, for example from reaction of propylene glycol with arabitol. Especially preferred polyols here are propane-1,3-diol, propylene glycol, glycerol, trimethylolethane, trimethylolpropane, sorbitan, sorbitol, isosorbide, erythritol, threitol, pentaerythritol, arabitol, xylitol, ribitol, fucitol, mannitol, galactitol, iditol, inositol, volemitol and glucose. Very particular preference is given to glycerol. Preferred polyol oligomers are oligomers of C₃-C₈ polyols having 1-20, preferably 2-10 and more preferably 2.5-8 repeat units. Especially preferred here are diglycerol, triglycerol, tetraglycerol, pentaglycerol, dierythritol, trierythritol, tetraerythritol, di(trimethylolpropane), tri(trimethylolpropane) and di- and oligosaccharides. Very particular preference is given to sorbitan and oligo- and/or polyglycerols. In particular, it is possible to use mixtures of different polyols. In addition, it is also possible to use alkoxylated adducts of C3-C8 polyols, oligomers thereof and/or co-oligomers thereof for preparation of the polyesters according to the invention, which can be obtained by reaction of C3-C8 polyols, oligomers thereof and/or co-oligomers thereof with alkylene oxides, for example ethylene oxide, propylene oxide and/or butylene oxide.

For preparation of the polyol esters according to the invention it is possible to use monocarboxylic acids and/or polyfunctional di- and/or tricarboxylic acids. Preferred carboxylic acids used for preparation of the polyol esters according to the invention conform to the general R—C(O)OH form where R is a monovalent aliphatic saturated or unsaturated hydrocarbon radical having 3 to 39 carbon atoms, preferably 7 to 21, more preferably having 9 to 17 carbon atoms. Especially preferred here are carboxylic acids selected from butyric acid (butanoic acid), caproic acid (hexanoic acid), caprylic acid (octanoic acid), capric acid (decanoic acid), lauric acid (dodecanoic acid), myristic acid (tetradecanoic acid), palmitic acid (hexadecanoic acid), stearic acid (octadecanoic acid), arachic acid (eicosanoic acid), behenic acid (docosanoic acid), lignoceric acid (tetracosanoic acid), palmitoleic acid ((Z)-9-hexadecenoic acid), oleic acid ((Z)-9-octadecenoic acid), elaidic acid ((E)-9-octadecenoic acid), cis-vaccenic acid ((Z)-11-octadecenoic acid), linoleic acid ((9Z,12Z)-9,12-octadecadienoic acid), alpha-linolenic acid ((9Z,12Z,15Z)-9,12,15-octadecatrienoic acid), gamma-linolenic acid ((6Z,9Z,12Z)-6,9,12-octadecatrienoic acid), di-homo-gamma-linolenic acid ((8Z,11Z,14Z)-8,11,14-eicosatrienoic acid), arachidonic acid ((5Z,8Z,11Z,14Z)-5,8,11,14-eicosatetraenoic acid), erucic acid ((Z)-13-docosenoic acid), nervonic acid ((Z)-15-tetracosenoic acid), ricinoleic acid, hydroxystearic acid and undecenyloic acid, and mixtures thereof, for example rapeseed oil acid, soya fatty acid, sunflower fatty acid, peanut fatty acid and tall oil fatty acid. Very particular preference is given to palmitic acid and stearic acid, and especially the mixtures of these substances.

Sources of suitable fatty acids or fatty acid esters, particularly glycerides, may be vegetable or animal fats, oils and waxes. For example, it is possible to use: pork lard, beef tallow, goose fat, duck fat, chicken fat, horse fat, whale oil, fish oil, palm oil, olive oil, avocado oil, seed kernel oils, coconut oil, palm kernel oil, cocoa butter, cottonseed oil, pumpkinseed oil, maize germ oil, sunflower oil, wheatgerm oil, grapeseed oil, sesame oil, linseed oil, soybean oil, peanut oil, lupin oil, rapeseed oil, mustard oil, castor oil, jatropha oil, walnut oil, jojoba oil, lecithin, for example based on soya, rapeseed or sunflowers, bone oil, neatsfoot oil, borage oil, lanolin, emu oil, deer tallow, marmot oil, mink oil, safflower oil, hemp oil, pumpkin oil, evening primrose oil, tall oil, and also carnauba wax, beeswax, candelilla wax, ouricury wax, sugarcane wax, retamo wax, caranday wax, raffia wax, esparto wax, alfalfa wax, bamboo wax, hemp wax, Douglas fir wax, cork wax, sisal wax, flax wax, cotton wax, dammar wax, tea wax, coffee wax, rice wax, oleander wax or wool wax.

In addition, it may be advantageous when the polyol esters according to the invention are produced using polyfunctional di- and tricarboxylic acids or cyclic anhydrides of di- and tricarboxylic acids, by means of which polyol polyesters are obtainable. Tetrafunctional and higher-functionality carboxylic acids or anhydrides thereof are likewise usable with preference in the context of this invention. Preference is given here to aliphatic linear or branched di- and/or tricarboxylic acids having a chain length of 2 to 18 carbon atoms and/or dimer fatty acids that have been obtained by catalytic dimerization of unsaturated fatty acids having 12 to 22 carbon atoms. Examples of corresponding polyfunctional acids are oxalic acid, malonic acid, succinic acid, glutaric acid, adipic acid, pimelic acid, suberic acid, azelaic acid, sebacic acid, brassylic acid, thapsic acid, tartronic acid, tartaric acid, malic acid or citric acid. Especially preferably, polyfunctional di- and tricarboxylic acids are used in combination with monofunctional carboxylic acids, as described above, by means of which partly crosslinked polyol esters are obtainable.

In a particularly preferred embodiment of the present invention, the polyol esters are selected from the group of the sorbitan esters and/or polyglycerol esters. Very particular preference is given to polyglycerol esters, in particular polyglycerol palmitate and polyglycerol stearate and mixtures of these substances.

Especially preferred here are polyglycerol esters conforming to the general formula 1:

MₐD_{b}T_{c} Formula 1

where
M=[C₃H₅(OR¹)₂O_{1/2}]
D=[C₃H₅(OR¹)₁O_{2/2}]
T=[C₃H₅O_{3/2}]
a=1 to 10, preferably 2 to 3, especially preferably 2,
b=0 to 10, preferably greater than 0 to 5, especially preferably 1 to 4,
c=0 to 3, preferably 0,
where the R¹ radicals are independently identical or different radicals of the R²—C(O)— form or H,
where R² is a monovalent aliphatic saturated or unsaturated hydrocarbon radical having 3 to 39 carbon atoms, preferably 7 to 21, more preferably having 9 to 17 carbon atoms,
where at least one R¹ radical corresponds to a radical of the R²—C(O)— form,

The structural elements M, D and T are joined here via oxygen bridges in each case. Two O_{1/2} radicals are always joined here to form an oxygen bridge (—O—), where any O_{1/2} radical may be joined only to one further O_{1/2} radical.

Even more preferred are polyglycerol esters corresponding to the general formula 2:

MₓD_{y}T_{z} Formula 2

where

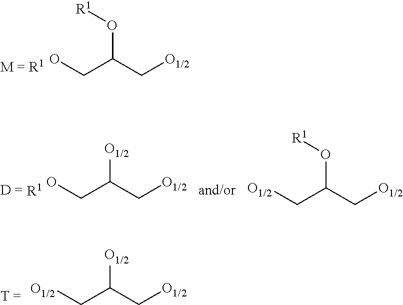

x=1 to 10, preferably 2 to 3, especially preferably 2,
y=0 to 10, preferably greater than 0 to 5, especially preferably 1 to 4,
z=0 to 3, preferably greater than 0 to 2, especially preferably 0,
with the proviso that at least one R¹ radical is not hydrogen, still R¹ as defined for formula 1.

Further preferred are polyglycerol esters of the general formula 3:

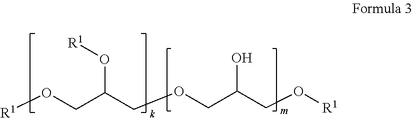

where
k=1 to 10, preferably 2 to 3, especially preferably 2,
m=0 to 10, preferably greater than 0 to 5, especially preferably 1 to 3,
with the proviso that at least one of the R¹ radicals is not hydrogen, still R¹ as defined for formula 1, and that the sum total of k+m is greater than zero and the fragments having the indices k and m are distributed statistically.

In the context of the present invention, the term “polyglycerol” is especially understood to mean a polyglycerol which may also contain glycerol. Consequently, for the purposes of calculating amounts, masses and the like, any glycerol fraction should also be taken into consideration. In the context of the present invention, polyglycerols are therefore also mixtures comprising at least one glycerol oligomer and glycerol. Glycerol oligomers should be understood in each case to mean all relevant structures, i.e., for example, linear, branched and cyclic compounds.

Statistical distributions are composed of blocks with any desired number of blocks and with any desired sequence, or randomized distribution; they can also have an alternating structure, or else form a gradient along the chain; in particular, they can also constitute any of the mixed forms in which groups of different distributions can optionally follow one another. Specific embodiments may lead to restrictions to the statistical distributions as a result of the embodiment. There is no change in the statistical distribution for all regions unaffected by the restriction.

Preferably, the polyglycerol esters usable in accordance with the invention have not more than 5, more preferably not more than 4 and even further preferably not more than 3 R¹ radicals of the R²—C(O)— form. The R¹ radical is especially preferably selected from the group of the carboxylic acids as described above.

In a likewise preferred embodiment of the present invention, polyglycerol esters used as additives in aqueous polymer dispersions are those obtainable by the reaction of at least one polyglycerol with at least one carboxylic acid as described above. Suitable reaction conditions for this reaction are temperatures preferably between 200 and 260° C. and preferably reduced pressure in the range between 20-800 mbar, preferably between 50 and 500 mbar, which enables easier removal of water.

In structural terms, the polyol esters can be characterized via wet-chemical indices, for example their hydroxyl number, their acid number and their hydrolysis number. Suitable determination methods for determining the hydroxyl number are especially those according to DGF C-V 17 a (53), Ph. Eur. 2.5.3 Method A and DIN 53240. Suitable methods for determining the acid number are especially those according to DGF C-V 2, DIN EN ISO 2114, Ph. Eur. 2.5.1, ISO 3682 and ASTM D 974. Suitable determination methods for determining the hydrolysis number are particularly those according to DGF C-V 3, DIN EN ISO 3681 and Ph. Eur. 2.5.6.

It is preferable in accordance with the invention and corresponds to a particularly preferred embodiment of the invention when, for preparation of the polyglycerol ester, a polyglycerol having a mean degree of condensation of 1-20, preferably of 2-10 and more preferably of 2.5-8 is used. The mean degree of condensation N can be determined here on the basis of the OH number (OHN, in mg KOH/g) of the polyglycerol and is linked thereto according to:

$$N = \frac{112200 - 18 \cdot OHN}{75 \cdot OHN - 56100}$$

The OH number of the polyglycerol can be determined here as described above. Consequently, preferred polyglycerols for preparation of the polyglycerol ethers according to the invention are especially those which have an OH number of 1829 to 824, more preferably of 1352-888 and especially preferably of 1244-920 mg KOH/g.

The polyglycerol used can be provided here by different conventional methods, for example polymerization of glycidol (e.g. base-catalyzed), polymerization of epichlorohydrin (for example in the presence of a base such as NaOH) or polycondensation of glycerol. According to the invention, preference is given to the provision of the polyglycerol by the condensation of glycerol, especially in the presence of catalytic amounts of a base, especially NaOH or KOH. Suitable reaction conditions are temperatures between 200 and 260° C. and reduced pressure in a range between 20 and 800 mbar, especially between 50 and 500 mbar, which enables easier removal of water. Moreover, various commercial polyglycerols are obtainable, for example from Solvay, Innovyn, Daicel and Spiga Nord S.p.A.

Both the reaction of polyglycerol and carboxylic acids, especially fatty acid and/or fatty acid esters (e.g. triglycerides), and the provision of the polyglycerol can be effected by widely used methods familiar to the person skilled in the art. Corresponding methods are described, for example, in the Römpp Chemie Lexikon [Römpp's Chemistry Lexicon] (Thieme-Verlag, 1996).

Preferred sorbitan esters in the context of this invention are those that are obtained by reaction of sorbitol or aqueous sorbitol solutions with at least one carboxylic acid as described above at temperatures of 200-260° C., optionally in the presence of suitable catalysts, giving primarily mixtures of 1,4 and 1,5 sorbitan esters. Corresponding methods are described, for example, in the Römpp Chemie Lexikon (Thieme-Verlag, 1996).

It has already been made clear that the term “polyol esters” in the context of the entire present invention also encompasses the ionic derivatives thereof, preferably the phosphorylated and sulfated derivatives, especially phosphorylated polyol esters. Phosphorylated polyol esters are obtainable here by reaction of the polyol esters with a phosphorylating reagent and optional, preferably obligatory, subsequent neutralization (cf. especially Industrial Applications of Surfactants. II. Preparation and Industrial Applications of Phosphate Esters. Edited by D. R. Karsa, Royal Society of Chemistry, Cambridge, 1990). Preferred phosphorylating reagents in the context of this invention are phosphorus oxychloride, phosphorus pentoxide (P₄O₁₀) and more preferably polyphosphoric acid. The term “phosphorylated polyol esters” over the entire scope of the present invention also covers the partly phosphorylated polyol esters, and the term “sulfated polyol esters” over the entire scope of the present invention likewise also covers the partly sulfated polyol esters.

In addition, ionic derivatives of the polyol esters over the entire scope of the present invention can also be obtained by reaction of the polyol esters with di- or tricarboxylic acid or corresponding cyclic anhydrides, more preferably succinic anhydride, and optional, preferably obligatory, neutralization. These polyol esters are usable with particular preference in the context of the present invention.

In addition, ionic derivatives of the polyol esters over the entire scope of the present invention can also be obtained by reaction of the polyol esters with unsaturated di- or tricarboxylic acid or corresponding cyclic anhydrides and subsequent sulfonation and optional, preferably obligatory, neutralization. These polyol esters too are usable with particular preference in the context of the present invention.

The term “neutralization” over the entire scope of the present invention also covers partial neutralization. For neutralization, including partial neutralization, it is possible to use customary bases. These include the water-soluble metal hydroxides, for example barium hydroxide, strontium hydroxide, calcium hydroxide, thallium (I) hydroxide and preferably the hydroxides of the alkali metals that dissociate into free metal and hydroxide ions in aqueous solutions, especially NaOH and KOH. These also include the anhydro bases which react with water to form hydroxide ions, for example barium oxide, strontium oxide, calcium oxide, lithium oxide, silver oxide and ammonia. As well as these aforementioned alkalis, solid substances usable as bases are also those which likewise give an alkaline reaction on dissolution in water without having HO— (in the solid compound); examples of these include amines such as mono-, di- and trialkylamines, which may also be functionalized alkyl radicals as, for example, in the case of amide amines, mono-, di- and trialkanolamines, mono-, di- and triaminoalkylamines, and, for example, the salts of weak acids, such as potassium cyanide, potassium carbonate, sodium carbonate, trisodium phosphate, etc.

In relation to ionic derivatives of the polyol esters according to the invention, preference is given very particularly to phosphorylated sorbitan esters and/or phosphorylated polyglycerol esters, in particular phosphorylated polyglycerol esters. In particular, phosphorylated and neutralized polyglycerol stearate and polyglycerol palmitate and mixtures of the two substances are preferred ionic derivatives of polyol esters in the context of this invention.

A particularly preferred embodiment of this invention envisages the use in accordance with the invention of polyol esters of the formula 1, 2 and/or 3, as specified above, with the additional proviso that they have been (at least partly) phosphorylated, such that these polyol esters of the formula 1, 2 and/or 3 especially bear at least one (R³O)₂P(O)-radical as the R¹ radical, where the R³ radicals are independently cations, preferably Na⁺, K⁺ or NH₄⁺, or ammonium ions of mono-, di- and trialkylamines, which may also be functionalized alkyl radicals as, for example, in the case of amide amines, of mono-, di- and trialkanolamines, of mono-, di- and triaminoalkylamines, or H or R⁴—O—, where R⁴ is a monovalent aliphatic saturated or unsaturated hydrocarbon radical having 3 to 39 carbon atoms, preferably 7 to 22 and more preferably having 9 to 18 carbon atoms or a polyol radical.

In the case of the sulfated polyol esters, preference is given especially to those obtainable by reaction of the polyol esters with sulfur trioxide or amidosulfonic acid. Preference is given here to sulfated sorbitan esters and/or sulfated polyglycerol esters, especially sulphated polyglycerol stearate and sulfated polyglycerol palmitate and mixtures of these two substances.

In the context of the present invention, it is also preferable when the ethylene oxide-rich alkyl alkoxylates used in combination with polyol esters conform to the general formula 4

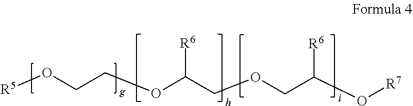

where
g=5 to 100, preferably 10 to 75, more preferably 25 to 50,
h=0 to 25, preferably 0 to 10, more preferably 0 to 5,
i=0 to 25, preferably 0 to 10, more preferably 0 to 5 and
where the R⁵ radical is a monovalent aliphatic saturated or unsaturated, linear or branched hydrocarbon radical having 5 to 40 carbon atoms, preferably 8 to 25, more preferably having 10 to 20 carbon atoms, or a fatty acid residue of the general formula R⁸—C(O) where R⁸ is a monovalent aliphatic saturated or unsaturated hydrocarbon radical having 3 to 39 carbon atoms, preferably 7 to 21, more preferably having 9 to 17 carbon atoms,
and where the R⁶ radicals are independently identical or different monovalent aliphatic or aromatic hydrocarbon radicals having 1 to 20 carbon atoms, preferably methyl radicals,
and where the R⁷ radical is a monovalent aliphatic or aromatic hydrocarbon radical having 1 to 20 carbon atoms or H, preferably a methyl radical or H, more preferably H.

As already described, the present invention envisages the combined use of polyol esters and ethylene oxide-rich alkyl ethoxylates, as described above, as foam additives in aqueous polymer dispersions, preferably in aqueous polyurethane dispersions, particular preference being given to filler-containing systems. The polymer dispersions here are preferably selected from the group of aqueous polystyrene dispersions, polybutadiene dispersions, poly(meth)acrylate dispersions, polyvinyl ester dispersions and polyurethane dispersions. The polymer content of these dispersions is preferably in the range of 20-70% by weight, more preferably in the range of 25-65% by weight. Particular preference is given in accordance with the invention to the use of polyol esters and ethylene oxide-rich alkyl alkoxylates as additives in aqueous polyurethane dispersions, especially in filler-containing aqueous polyurethane dispersions. Especially preferable here are polyurethane dispersions based on polyester polyols, polyester amide polyols, polycarbonate polyols, polyacetal polyols and polyether polyols.

In the context of the present invention, it is preferable when the total concentration of polyol esters and ethylene oxide-rich alkyl alkoxylates, based on the total weight of the aqueous polymer dispersion, is in the range of 0.2-20% by weight, more preferably in the range of 0.4-15% by weight, especially preferably in the range of 0.5-10% by weight.

It is additionally preferred when ethylene oxide-rich alkyl alkoxylates are used in a concentration of 5-80% by weight, preferably of 10-75% by weight, more preferably of 25-65% by weight, based on the overall mixture of polyol esters and alkyl alkoxylates.

It is additionally preferred in the context of the present invention when, in addition to the combination of polyol esters and ethylene oxide-rich alkyl alkoxylates, at least one further cosurfactant is used as additives in aqueous polymer dispersions. Cosurfactants preferred in accordance with the invention are, for example, fatty acid amides, ethylene oxide-propylene oxide block copolymers, betaines, for example amidopropyl betaines, amine oxides, quaternary ammonium surfactants or amphoacetates. In addition, the cosurfactant may comprise silicone-based surfactants, for example trisiloxane surfactants or polyether siloxanes.

Especially preferred cosurfactants are ionic, preferably anionic, cosurfactants. Preferred anionic cosurfactants here are ammonium and/or alkali metal salts of fatty acids, alkyl sulfates, alkyl ether sulfates, alkylsulfonates, alkylbenzenesulfonates, alkyl phosphates, alkyl sulfosuccinates, alkyl sulfosuccinamates and alkyl sarcosinates. Especially preferred here are alkyl sulfates having 12-20 carbon atoms, more preferably having 14-18 carbon atoms, even more preferably having more than 16-18 carbon atoms. In the case of ammonium and/or alkali metal salts of fatty acids, it is preferable when they contain less than 25% by weight of stearate salts, and are especially free of stearate salts.

When cosurfactants are used, it is especially preferred when the proportion of additional cosurfactant based on the total amount of polyol ester, ethylene oxide-rich alkyl alkoxylate and additional cosurfactant is in the range of 0.1-50% by weight, preferably in the range of 0.2-40% by weight, more preferably in the range of 0.5-30% by weight, even more preferably in the range of 1-25% by weight.

As described above, the present invention more preferably provides for the joint use of polyol esters and ethylene oxide-rich alkyl alkoxylates as foam additives in filler-containing polymer dispersions. Fillers preferred in accordance with the invention in this context are selected from the group of the silicates, for example talc, mica or kaolin, of the carbonates, for example calcium carbonate or chalk, of the oxides/hydroxides, for example quartz flour, silica, aluminium/magnesium hydroxide, magnesium oxide or zinc oxide, and of the organic fillers, for example pulp, cellulose and cellulose derivatives, lignin, wood fibers/wood flour, ground plastics or textile fibers. Very particular preference is given here in accordance with the invention to kaolin, mica, calcium carbonate, silicates, lignin and cellulose derivatives.

In addition, it is preferable in accordance with the invention when fillers are used in concentrations of 5-70% by weight, more preferably of 10-50% by weight, even more preferably of 15-45% by weight, even more preferably of 20-40% by weight, based on the total weight of the aqueous polymer dispersion.

As well as the inventive combination of polyol esters and ethylene oxide-rich alkyl alkoxylates, the aqueous polymer dispersions may also comprise further additives such as color pigments, flatting agents, stabilizers such as hydrolysis or UV stabilizers, antioxidants, absorbers, crosslinkers, levelling additives, thickeners or optionally other cosurfactants as described above.

Polyol esters and ethylene oxide-rich alkyl alkoxylate can be added to the aqueous dispersion either in pure or blended form in a suitable solvent. In this case, it is possible to blend the two components beforehand in a solvent or separately in two different solvents. It is also possible to blend just one of the two components in a suitable solvent beforehand, while the other component is added in pure form to the aqueous dispersion. The blending of polyol ester and ethylene oxide-rich alkyl alkoxylate in a solvent (mixture) to give a one-component additive mixture corresponds here to a very particularly preferred embodiment of the present invention. Preferred solvents in this connection are selected from water, propylene glycol, dipropylene glycol, polypropylene glycol, butyldiglycol, butyltriglycol, ethylene glycol, diethylene glycol, polyethylene glycol, polyalkylene glycols based on EO, PO, BO and/or SO, and mixtures of these substances, very particular preference being given to aqueous dilutions or blends. Blends or dilutions of polyol ester and/or ethylene oxide-rich alkyl alkoxylates preferably contain additive concentrations of 10-80% by weight, more preferably 15-70% by weight, even more preferably 20-60% by weight.

In the case of aqueous dilutions or blends of polyol esters and/or ethylene oxide-rich alkyl alkoxylates, it may be advantageous when hydrotropic compounds are added to the blend to improve the formulation properties (viscosity, homogeneity, etc.). Hydrotropic compounds here are water-soluble organic compounds consisting of a hydrophilic part and a hydrophobic part, but are too low in molecular weight to have surfactant properties. They lead to an improvement in the solubility or in the solubility properties of organic, especially hydrophobic organic, substances in aqueous formulations. The term “hydrotropic compounds” is known to those skilled in the art. Preferred hydrotropic compounds in the context of the present invention are alkali metal and ammonium toluenesulfonates, alkali metal and ammonium xylenesulfonates, alkali metal and ammonium naphthalenesulfonates, alkali metal and ammonium cumenesulfonates, and phenol alkoxylates, especially phenyl ethoxylates, having up to 6 alkoxylate units. Blends of polyol ester and/or ethylene oxide-rich alkyl alkoxylate may additionally optionally comprise further cosurfactants as described above.

Since, as described above, the joint use of polyol esters and ethylene oxide-rich alkyl alkoxylates leads to a distinct improvement in porous polymer coatings produced from aqueous polymer dispersions, especially in the case of filler-containing polymer dispersions, the present invention likewise provides aqueous polymer dispersions comprising at least one of the polyol esters according to the invention and at least one of the ethylene oxide-rich alkyl alkoxylates according to the invention, as described in detail above.

The present invention also provides porous polymer layers produced from aqueous polymer dispersions, preferably filler-containing aqueous polymer dispersions, obtained with the joint use according to the invention of polyol esters and ethylene oxide-rich alkyl alkoxylates as foam additives, as described in detail above.

Preferably, the porous polymer coatings according to the invention can be produced by a process comprising the steps of
a) providing a mixture comprising at least one aqueous polymer dispersion, preferably at least one filler, at least one of the polyol esters according to the invention, at least one of the ethylene oxide-rich alkyl alkoxylates according to the invention and optionally further additives,
b) foaming the mixture to give a homogeneous, fine-cell foam,
c) optionally adding at least one thickener to adjust the viscosity of the wet foam,
d) applying a coating of the foamed polymer dispersion to a suitable carrier,
e) drying/curing the coating.

With a view to preferred configurations, especially with a view to the polyol esters, ethylene oxide-rich alkyl alkoxylates, polymer dispersions and fillers that are usable with preference in the process, reference is made to the preceding description and also to the aforementioned preferred embodiments, especially as detailed in the claims.

It is made clear that the process steps of the process according to the invention as set out above are not subject to any fixed sequence in time. For example, process step c) can be executed at an early stage, at the same time as process step a).

It is a preferred embodiment of the present invention when, in process step b), the aqueous polymer dispersion is foamed by the application of high shear forces. The foaming can be effected here with the aid of shear units familiar to the person skilled in the art, for example Dispermats, dissolvers, Hansa mixers or Oakes mixers.

In addition, it is preferable when the wet foam produced at the end of process step c) has a viscosity of at least 5, preferably of at least 10, more preferably of at least 15 and even more preferably of at least 20 Pa·s, but of not more than 500 Pa·s, preferably of not more than 300 Pa·s, more preferably of not more than 200 Pa·s and even more preferably of not more than 100 Pa·s. The viscosity of the foam can be determined here, for example, with the aid of a Brookfield viscometer, LVTD model, equipped with an LV-4 spindle. Corresponding test methods for determination of the wet foam viscosity are known to those skilled in the art.

As already described above, additional thickeners can be added to the system to adjust the wet foam viscosity.

Preferably, the thickeners which can be used advantageously in the context of the invention are selected here from the class of the associative thickeners. Associative thickeners here are substances which lead to a thickening effect through association at the surfaces of the particles present in the polymer dispersions. The term is known to those skilled in the art. Preferred associative thickeners are selected here from polyurethane thickeners, hydrophobically modified polyacrylate thickeners, hydrophobically modified polyether thickeners and hydrophobically modified cellulose ethers. Very particular preference is given to polyurethane thickeners. In addition, it is preferable in the context of the present invention when the concentration of the thickeners based on the overall composition of the dispersion is in the range of 0.01-10% by weight, more preferably in the range of 0.05-5% by weight, most preferably in the range of 0.1-3% by weight.

In the context of the present invention, it is additionally preferable when, in process step d), coatings of the foamed polymer dispersion with a layer thickness of 10-10 000 μm, preferably of 50-5000 μm, more preferably of 75-3000 μm, even more preferably of 100-2500 μm, are produced. Coatings of the foamed polymer dispersion can be produced by methods familiar to the person skilled in the art, for example knife coating. It is possible here to use either direct or indirect coating processes (called transfer coating).

It is also preferable in the context of the present invention when, in process step e), the drying of the foamed and coated polymer dispersion is effected at elevated temperatures. Preference is given here in accordance with the invention to drying temperatures of min. 50° C., preferably of 60° C., more preferably of at least 70° C. In addition, it is possible to dry the foamed and coated polymer dispersions in multiple stages at different temperatures, in order to avoid the occurrence of drying defects. Corresponding drying techniques are widespread in industry and are known to those skilled in the art.

As already described, process steps c)-e) can be effected with the aid of widely practised methods known to those skilled in the art. An overview of these is given, for example, in “Coated and laminated Textiles” (Walter Fung, CR-Press, 2002).

In the context of the present invention, preference is given especially to those porous polymer coatings comprising polyol esters, ethylene oxide-rich alkyl alkoxylates and preferably fillers and optionally further additives that have a mean cell size of less than 350 μm, preferably less than 200 μm, especially preferably less than 150 μm, most preferably less than 100 μm. The mean cell size can preferably be determined by microscopy, preferably by electron microscopy. For this purpose, a cross section of the porous polymer coating is viewed by means of a microscope with sufficient magnification and the size of at least 25 cells is ascertained. In order to obtain sufficient statistics for this evaluation method, the magnification of the microscope should preferably be chosen such that at least 10×10 cells are present in the observation field. The mean cell size is then calculated as the arithmetic mean of the cells or cell sizes viewed. This determination of cell size by means of a microscope is familiar to the person skilled in the art.

The porous polymer layers (or polymer coatings) according to the invention, comprising polyol esters, ethylene oxide-rich alkyl alkoxylates and preferably fillers and optionally further additives, can be used, for example, in the textile industry, for example for synthetic leather materials, in the building and construction industry, in the electronics industry, for example for foamed seals, in the sports industry, for example for production of sports mats, or in the automotive industry.

### EXAMPLES

### Substances

Impranil® DLU: aliphatic polycarbonate ester-polyether-polyurethane dispersion from Covestro

Additive 1: polyglycerol-3 stearate prepared by reaction of 103.3 g of polyglycerol (OHN=1124 mg KOH/g, Mw=240 g/mol) with technical grade stearic acid (palmitic acid:stearic acid=50:50; 155.0 g).

Additive 2: Alkyl ethoxylate corresponding to formula 4 with R₅=lauryl, R₇=H, g=40 and h=i=0.

### Viscosity Measurements

All viscosity measurements were conducted with a Brookfield viscometer, LVTD model, equipped with an LV-4 spindle, at a constant rotation speed of 12 rpm. For the viscosity measurements, the samples were transferred into a 100 ml jar into which the measurement spindle was immersed as far as the immersion marking. The display of a constant viscometer measurement was always awaited.

### Example 1: Formulation of Inventive Surfactant Blends

Surfactant blends were produced in accordance with the compositions detailed in Table 1. All blends were homogenized at 80° C.:

TABLE 1
Composition of surfactant blends used hereinafter

| | Surfactant 1 | Surfactant 2 | Surfactant 3 |
|---|---|---|---|
| Additive 1 | 22.2 g | 14.8 g | — |
| Additive 2 | — | 25 g | 50 g |
| Cetearyl sulfate | 1.8 g | 1.2 g | 2.4 g |
| Water | 69.7 g | 52. g | 40.3 g |
| Propylene | 6.3 g | 6.3 g | 6.3 g |
| glycol | | | |

### Example 2: Foaming Experiments

To test the efficacy of the additive combination according to the invention, a series of foaming experiments was conducted. For this purpose, the polyurethane dispersion Impranil DLU and kaolin (numerical median particle size D50: 5 μm) as filler were used. For these foaming experiments, the surfactant blends described in Example 1 were used. Surfactant 2 corresponds here to the additive combination according to the invention of polyol ester and ethylene oxide-rich alkyl alkoxylate; Surfactant 1 and 3 serve as comparative examples in order to show the improved effect of the additive combination according to the invention compared to the respective individual components. Table 2 gives an overview of the composition of the respective experiments.

All foaming experiments were conducted manually. For this purpose, polyurethane dispersion, filler and surfactant were first placed in a 500 ml plastic cup and homogenized with a dissolver equipped with a dispersing disc (diameter=6 cm) at 800 rpm for 3 min. For foaming of this filler-containing dispersion, the shear rate was then increased to 2200 rpm, ensuring that the dissolver disc was always immersed into the dispersion to a sufficient degree that a proper vortex formed. At this speed, the mixtures were foamed to a volume of about 350 ml (if this was permitted by the viscosity of the dispersion). Thereafter, the shear rate was reduced to 1000 rpm and shearing was effected for another 15 min. In this step, the dissolver disc was immersed sufficiently deeply into the mixtures that no further air was introduced into the system, but the complete volume was still in motion.

In the case of foams produced with the inventive surfactant mixture 2 (experiment #2), fine, homogeneous foams within the desired density range were obtained at the end of the foaming operation, and were still free-flowing and had good processibility. In the case of the surfactant blend that contained only polyglycerol ester (experiment #1), the viscosity of the filler-containing dispersion was so high that foaming of the samples was impossible. Moreover, the viscosity of the mixtures was so high that they were further processible only with difficulty. In the case of the surfactant blend that contained only the ethylene oxide-rich alkyl alkoxylate (experiment #3), the viscosity of the filler-containing dispersion was within an acceptable window, but comparatively irregular, coarse-cell foams were obtained at the end of the foaming operation. The viscosities of the foams are likewise noted in Table 2.

The foams were then knife-coated onto a textile carrier (layer thickness ˜800 μm) with the aid of a Labcoater LTE-S laboratory spreading table/dryer from Mathis AG and then dried at 60° C. for 5 min and at 120° C. for a further 5 min. It was noticeable here that the foams produced with the inventive surfactant mixture 2 (experiment #2) could be knife-coated in a defect-free manner. After the drying operation, defect-free foam coatings with a visually homogeneous appearance and good tactile properties were obtained. In the case of the surfactant blend that contained only polyglycerol ester (experiment #1), knife-coating of the foams was possible only with difficulty, which resulted in defect sites in the foam coating. After the drying, coatings having a number of faults were thus obtained. This, and also the fact that only a lightly foamed compact mass was knife-coated, had the additional effect that corresponding samples felt very hard and rigid and had less appealing tactile properties. In the case of the surfactant blend that contained only the ethylene oxide-rich alkyl alkoxylate (experiment #3), the foams could be knife-coated onto the textile carrier in a defect-free manner. After the drying, however, the inhomogeneous, coarse-cell structure of the foam coating was still apparent. This likewise led to less appealing tactile properties of the coated textile. These experiments thus clearly show the improved effect of the foam additive combination according to the invention.

TABLE 2
Overview of foam formulations

| | #1 | #2 | #3 |
|---|---|---|---|
| Impranil ® DLU | 150 g | 150 g | 150 g |
| Kaolin | 60 g | 60 g | 60 g |
| Surfactant 1 | 6 g | — | — |
| Surfactant 2 | — | 9 g | — |
| Surfactant 3 | — | — | 4.5 g |
| Wet foam | >500 | 150 | 130 |
| viscosity [Pa s] | | | |

1. A foam additive for an aqueous polymer dispersion, the foam additive comprising a polyol ester and an ethylene oxide-rich alkyl alkoxylate, wherein the aqueous polymer dispersion may be an aqueous polyurethane dispersions or a filler-containing aqueous polyurethane dispersion.

2. The foam additive according to claim 1, wherein the polyol ester is obtained by the esterification of a polyol with at least one carboxylic acid.

3. The foam additive according to claim 2, wherein the polyol is selected from the group of the C₃-C₈ polyols and oligomers thereof.

4. The foam additive according to claim 2, wherein the carboxylic acid conforms to the general formula R—C(O)OH where R is a monovalent aliphatic saturated or unsaturated hydrocarbon radical having 3 to 39 carbon atoms,
and where preferred carboxylic acids are selected from the group consisting of butyric acid (butanoic acid), caproic acid (hexanoic acid), caprylic acid (octanoic acid), capric acid (decanoic acid), lauric acid (dodecanoic acid), myristic acid (tetradecanoic acid), palmitic acid (hexadecanoic acid), stearic acid (octadecanoic acid), arachic acid (eicosanoic acid), behenic acid (docosanoic acid), lignoceric acid (tetracosanoic acid), palmitoleic acid ((Z)-9-hexadecenoic acid), oleic acid ((Z)-9-hexadecenoic acid), elaidic acid ((E)-9-octadecenoic acid), cis-vaccenic acid ((Z)-11-octadecenoic acid), linoleic acid ((9Z,12Z)-9,12-octadecadienoic acid), alpha-linolenic acid ((9Z,12Z,15Z)-9,12,15-octadecatrienoic acid), gamma-linolenic acid ((6Z,9Z,12Z)-6,9,12-octadecatrienoic acid), di-homo-gamma-linolenic acid ((8Z,11Z,14Z)-8,11,14-eicosatrienoic acid), arachidonic acid ((5Z,8Z,11Z,14Z)-5,8,11,14-eicosatetraenoic acid), erucic acid ((Z)-13-docosenoic acid), nervonic acid ((Z)-15-tetracosenoic acid), ricinoleic acid, hydroxystearic acid and undecenyloic acid, and mixtures thereof, for example rapeseed oil acid, soya fatty acid, sunflower fatty acid, peanut fatty acid and tall oil fatty acid.

5. The foam additive according to claim 1, wherein the polyol ester used include those that are selected from the group consisting of the sorbitan esters and polyglycerol esters, wherein the polyglycerol esters conform to the general formula 2:
MₐD_{b}T_{c} Formula 1
where
M=[C₃H₅(OR¹)₂O_{1/2}]
D=[C₃H₅(OR¹)₁O_{2/2}]
T=[C₃H₅O_{3/2}]
a=1 to 10,
b=0 to 10,
c=0 to 3,
where the R² radicals are independently identical or different radicals of the R²—C(O)— form or H,
where R² is a monovalent aliphatic saturated or unsaturated hydrocarbon radical having 3 to 39 carbon atoms,
where at least one R¹ radical corresponds to a radical of the R²—C(O)— form,
and/or conform to the general formula 2:
MₓD_{y}T_{z} Formula 2
where 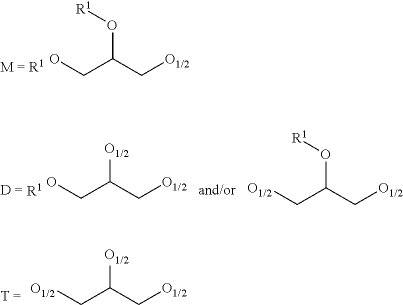
x=1 to 10,
y=0 to 10,
z=0 to 3,
wherein at least one R¹ radical is not hydrogen, still R¹ as defined above,
and/or conform to the general formula 3: 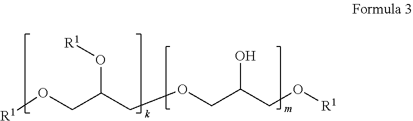
where
k=1 to 10,
m=0 to 10,
wherein at least one of the R¹ radicals is not hydrogen, still R¹ as defined above, and that the sum total of k+m is greater than zero and the fragments having the indices k and m are distributed statistically.

6. The foam additive according to claim 1, wherein the polyol esters of the formula 1, 2 and/or 3 have been phosphorylated, especially bear at least one (R³O)2P(O)— radical as the R¹ radical, where the R³ radicals are independently cations, or ammonium ions of mono-, di- and trialkylamines, which may also be functionalized alkyl radicals as, for example, in the case of amide amines, of mono-, di- and trialkanolamines, of mono-, di- and triaminoalkylamines, or H or R⁴—O—,
where R⁴ is a monovalent aliphatic saturated or unsaturated hydrocarbon radical having 3 to 39 carbon atoms.

7. The foam additive according to claim 1, wherein the ethylene oxide-rich alkyl alkoxylates conform to the general formula 4 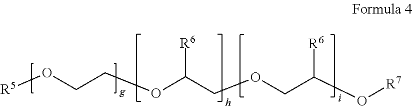
where
g=5 to 100,
h=0 to 25,
i=0 to 25,
where the R⁵ radical is a monovalent aliphatic saturated or unsaturated, linear or branched hydrocarbon radical having 5 to 40 carbon atoms,
and where the R⁶ radicals are independently identical or different monovalent aliphatic or aromatic hydrocarbon radicals having 1 to 20 carbon atoms,
and where the R⁷ radical is a monovalent aliphatic or aromatic hydrocarbon radical having 1 to 20 carbon atoms or H.

8. The foam additive according to claim 1, wherein the aqueous polymer dispersions are selected from the group consisting of aqueous polystyrene dispersions, polybutadiene dispersions, poly(meth)acrylate dispersions, polyvinyl ester dispersions and polyurethane dispersions, where the polymer content of these dispersions is preferably in the range of from 20-70% by weight.

9. The foam additive according to claim 1, wherein the aqueous polymer dispersion contain fillers selected from the group of the silicates selected from the group consisting of talc, mica or kaolin, of the carbonates selected from the group consisting of calcium carbonate or chalk, of the oxides/hydroxides such as quartz flour, silica, aluminium/magnesium hydroxide, magnesium oxide or zinc oxide, and of the organic fillers including pulp, cellulose and cellulose derivatives, lignin, wood fibers/wood flour, ground plastics or textile fibers,
wherein the concentration of the fillers is in the range of from 10-50% by weight, based on the total weight of the aqueous polymer dispersion.

10. The foam additive according to claim 1, wherein the total concentration of polyol ester and ethylene oxide-rich alkyl ethoxylate is in the range of from 0.2-20% by weight, based on the total weight of the aqueous polymer dispersion.

11. The foam additive according to claim 1, wherein the ethylene oxide-rich alkyl ethoxylate is used in a concentration of from 5-80% by weight, based on the overall mixture of polyol ester alkyl alkoxylates.

12. The foam additive according to claim 1, wherein, in addition to the additive combination of polyol ester and ethylene oxide-rich alkyl alkoxylates, at least one further ionic cosurfactant is additionally used as additives in aqueous polymer dispersions,
ionic cosurfactants selected from the group consisting of ammonium and alkali metal salts of fatty acids, alkyl sulfates, alkyl ether sulfates, alkylsulfonates, alkylbenzenesulfonates, alkyl phosphates, alkyl sulfosuccinates, alkyl sulfosuccinamates and alkyl sarcosinates,
wherein the proportion of cosurfactant based on the total amount of polyol ester, ethylene oxide-rich alkyl alkoxylate and cosurfactant is in the range of from 0.1-50% by weight, by weight.

13. An aqueous polymer dispersion comprising polyol esters and ethylene oxide-rich alkyl alkoxylates, with the provisos as expressed in claim 1.

14. A process for producing a porous polymer coating with the foam additive of claim 1 as additives in aqueous polymer dispersions, comprising the steps of
a) providing a mixture comprising at least one aqueous polymer dispersion, preferably at least one filler, at least one polyol ester, at least one ethylene oxide-rich alkyl alkoxylate and optionally further additives,
b) foaming the mixture to give a homogeneous, fine-cell foam,
c) optionally adding at least one thickener to adjust the viscosity of the wet foam,
d) applying a coating of the foamed polymer dispersion to a suitable carrier,
e) drying the coating.

15. A porous polymer coating obtainable by the joint use of polyol esters and ethylene oxide-rich alkyl alkoxylates as additives in aqueous polymer dispersions, preferably filler-containing polymer dispersions, in the production of such polymer coatings, obtained by a process according to claim 14,
wherein the porous polymer coating has an average cell size less than 150 μm.

16. A porous polymer polyurethane coating obtained by the process according to claim 14,
wherein the porous polymer coating has an average cell size less than 75 μm.

17. The foam additive according to claim 2, wherein the polyol is selected from the group of the C₃-C₈ oligomers thereof
polyol oligomers selected from the group consisting of C3-C8 polyols having 1-20, repeat units, including diglycerol, triglycerol, tetraglycerol, pentaglycerol, dierythritol, trierythritol, tetraerythritol, di(trimethylolpropane), tri(trimethylolpropane) and di- and oligosaccharides, especially sorbitan and oligo- and/or polyglycerols.

18. The foam additive according to claim 2, wherein the carboxylic acid conforms to the general formula R—C(O)OH where R is a monovalent aliphatic saturated or unsaturated hydrocarbon radical having 9 to 17 carbon atoms.

19. The foam additive according to claim 1, wherein the polyol ester used include those that are selected from the group consisting of the sorbitan esters and polyglycerol esters, wherein the polyglycerol esters conform to the general formula 2:
MₐD_{b}T_{c} Formula 1
where
M=[C₃H₅(OR¹)₂O_{1/2}]
D=[C₃H₅(OR¹)₁O_{2/2}]
T=[C₃H₅O_{3/2}]
a=2,
b=1 to 4,
c=0,
where the R¹ radicals are independently identical or different radicals of the R²—C(O)— form or H,
where R² is a monovalent aliphatic saturated or unsaturated hydrocarbon radical having 9 to 17 carbon atoms,
where at least one R¹ radical corresponds to a radical of the R²—C(O)— form, and/or conform to the general formula 2:
MₓD_{y}T_{z} Formula 2
where 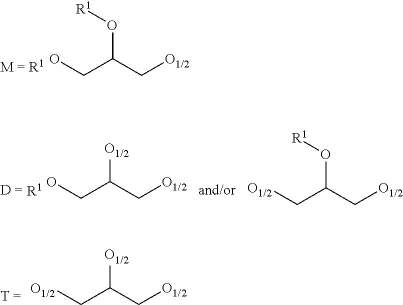
x=2,
y=1 to 4,
z=0,
wherein at least one R¹ radical is not hydrogen, still R¹ as defined above,
and/or conform to the general formula 3: 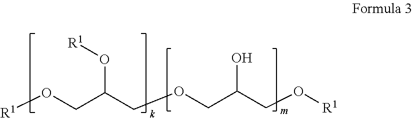
where
k=2,
m=1 to 3,
wherein at least one of the R¹ radicals is not hydrogen, still R¹ as defined above, and that the sum total of k+m is greater than zero and the fragments having the indices k and m are distributed statistically.

20. An aqueous polyurethane dispersion comprising polyol esters and ethylene oxide-rich alkyl alkoxylates, in accordance with claim 1.
